(19) United States
(12) Patent Application Publication
(10) Pub. No.: US 2005/0035069 A1
(43) Pub. Date: Feb. 17, 2005

(54) Method for removal of MTBE from water

(76) Inventor: Bruce W. Page, El Cerrito, CA (US)

Correspondence Address: Attn: Michael E. Dergosits;DERGOSITS & NOAH LLP, Suite 1450, Four Embarcadero Center, San Francisco, CA, 94111, US

(21) Appl. No.: 10/884,619

(22) Filed: Jul. 6, 2004

Related U.S. Application Data
(63) Continuation of application No. 10/205,287, filed on Jul. 24, 2002.
(60) Provisional application No. 60/310,086, filed on Aug. 3, 2001.

(51) Int. Cl. B01D 19/00

(52) U.S. Cl. 210/767; 95/263

(57) ABSTRACT

A method of removing MTBE from an aqueous solution. A counter-current air stripper is employed in carrying out the present method configured in the form of a substantially cylindrical column having a top and a bottom, a substantially circular cross section and longitudinal axis. An inlet is provided for the aqueous solution containing MTBE proximate the top of the column and an inlet is provided for air proximate the bottom of the column such that the aqueous solution is caused to gravitationally travel within the column while the air moves upward in a counter-current fashion. The column is at least partially packed with open spherical balls having internal ribs.

### RELATED APPLICATIONS

The present application relates to provisional application Ser. No. 60/310,086 filed on Aug. 3, 2001, the date of which is relied upon herein.

### TECHNICAL FIELD OF THE INVENTION

The present invention deals with an improved method for removing MTBE in ground water and in other areas contaminated by this commonly employed additive to gasoline products.

### BACKGROUND OF THE INVENTION

The United States Environmental Protection Agency (EPA), in 1992, began to mandate the reformulation of gasoline sold in carbon monoxide (CO) and ozone non-attainment areas in order to reduce emissions of CO and unburned hydrocarbons to the atmosphere. Reformulation requires the inclusion of oxygen-containing compounds in the complex mixture of compounds that constitutes gasoline. The presence of these so-called oxygenates in an automobile's fuel leads to more complete combustion and therefore lower concentrations of CO and hydrocarbons in the exhaust gases. This has been shown to be especially true for older automobiles. Although there are several oxygenates used by the refining industry, two of them, ethanol and methyl t-butyl ether (MTBE), have captured the largest share of the market. MTBE has been in use as an octane booster in gasoline since 1979. By 1992 the production of MTBE to satisfy reformulation requirements had reached 9.1 billion pounds according to the Western States Petroleum Association.

Virtually everyone is familiar with the problem of gasoline released to the environment, most frequently from underground tanks at service stations. The fact that thousands of fuel tanks have leaked has led to a massive clean-up program at great expense. However, the addition of oxygenates, and especially MTBE, to gasoline has complicated this clean-up effort. The reasons for this follow from a comparison of the properties of this ether with those of un-reformulated gasoline, or more simply, with the properties of BTEX compounds (benzene, toluene, ethyl benzene and xylene).

The BTEX compounds are the most toxic present in gasoline as marketed in this country, at least since lead and the halogenated compounds added with it were banned by the EPA. The following table gives some of the most important properties of these compounds for treatment design.

TABLE 1
Physical and Chemical Properties of BTEX and MTBE

| Property | Benzene | Toluene | Et-benzene | Xylene | MTBE |
|---|---|---|---|---|---|
| Mol. Weight | 78.11 | 92.14 | 106.17 | 106.17 | 88.15 |
| Spec. Grav. | 0.88 | 0.867 | 0.867 | 0.88 | 0.744 |
| Sol., mg/L | 1730 | 534.8 | 161 | 175 | 50,000 |
| Vap. Press., | 76 | 28.4 | 9.53 | 6.6 | 250 |
| mm-Hg | | | | | |
| H | 0.23 | 0.272 | 0.336 | 0.212 | 0.024 |
| Log K_{ow} | 2.36 | 2.73 | 3.24 | 3.10 | 1.20 |

The specific gravity, solubility in water, vapor pressure and H are all given for a temperature of 25° C. The Henry's Law Constant (H) is a measure of the partition of a compound between water and air. That is, it is the ratio of the concentration of the compound in air (C_{g}) to its concentration in water (Cₗ) when the two phases are at equilibrium,
H=C_{g}/Cₗ (Eq. 1)

It is widely understood that H is the single most important property to indicate the ease of transferring a compound from the water phase to the air phase. A higher value of H is clearly favorable to such a transfer. A review of the data in the table shows that the volatility of a compound (its vapor pressure) is not sufficient to judge a compound's tendency to partition into the air phase. MTBE has a much higher vapor pressure than benzene, the most volatile of the BTEX compounds, but its Henry's Law Constant is only one-tenth that of benzene. The reason for this is found in a comparison of the water solubilities for the two compounds. The much greater solubility of MTBE makes it much harder to transfer from water into the air phase.

The significance of this for the problem of cleaning up a gasoline spill can be understood when one realizes that the most economical technology available for the removal of gasoline from an impacted groundwater is air stripping. Because of the relatively favorable Henry's Law Constants for the BTEX compounds, it is easy to design, build and operate a device, the air stripper, to transfer BTEX from the water phase to the air phase. If necessary, the air stream leaving the stripper can be treated to remove the BTEX compounds before discharge to the atmosphere.

However, if the released gasoline is reformulated with MTBE, it is no longer an easy task to design and operate an air stripper to meet regulatory clean-up standards. In fact, it is not unusual to see a groundwater treatment system with an air stripper, a vapor-phase carbon absorber on the air stream, and a liquid-phase carbon absorber on the water leaving the stripper. Of course this significantly increases the capital cost of the system. In addition, the operating cost is also adversely effected because MTBE is very poorly adsorbed on liquid-phase carbon, which leads to frequent carbon change-outs.

According to the American Chemical Society, there are now an estimated 9,000 to 12,000 wells impacted by MTBE in the United States. In at least 12 states there are one or more municipal water systems that have a serious problem with this contaminant. Therefore, there is a need for an improved method for removing MTBE from water.

The main alternatives to air stripping have been identified as adsorption (carbon or synthetic resins) and advanced oxidation (hydrogen peroxide and ultraviolet light; ozone and ultraviolet light; or hydrogen peroxide and ozone) as suggested by researchers at University of California, Davis. These technologies are all considerably more expensive to install and operate than air stripping.

It has been frequently proposed to raise the temperature of the water before air stripping as a means of improving the removal of dissolved organic compounds, including MTBE. This is based on the fact that the Henry's Law Constant increases with temperature. However, this method of improving performance has at least three disadvantages. The need for a source of heat is the most obvious, but it is also a fact that most of the components of gasoline are biodegradable in oxygen-rich water and that raising the temperature increases the rate of those aerobic reactions. The result is that a heated air stripper in this application will experience serious fouling from biological growth. It is also true that the groundwater requiring treatment is often prone to forming inorganic scale and that this tendency will increase if the temperature is raised. In addition, if the air stream from the stripper must be treated before discharge, increasing its temperature will decrease the performance of vapor phase carbon. Therefore, the costs and operational difficulty, such as downtime for cleaning, are significantly increased in this attempt to improve the performance of an air stripper.

However, there is another operational variable that can be manipulated in order to improve the performance of an air stripper. As explained by Beck and Schuliger (Beck, Andreas and Wayne Schuliger, A New Air Stripping Method to Economically Remove VOCs from Groundwater, Fifth Forum on Innovative Hazardous Waste Treatment Technologies: Domestic and International, Chicago, Ill., May 3-5, 1994), if the air stripper is run under a partial vacuum, the stripping factor for the operation is increased. The stripping factor is a combination of the Henry's Law Constant, the total pressure in the stripper, and the air-to-water ratio
R=(H/Pₛ)(G/L) (Eq. 2)
where:
R=stripping factor
Pₛ=total pressure
G=air flow rate
L=water flow rate

It is clear from this expression that lowering the value of Pₛ will increase the value of R. And an increase in the value of R will result in an improvement in the performance of the air stripper.

The disadvantages of raising the water temperature are also eliminated by this approach to system improvement. There is no need for a source of heat; biological growth is now suppressed by a lack of oxygen; inorganic scale formation is reduced rather than enhanced; and vapor phase carbon performance will be improved due to the elevated concentration of MTBE in the air stream from the stripper, the lower water content of the air and its ambient temperature.

Apparently reducing the system pressure is not sufficient to improve the performance of an air stripper for MTBE removal however. Mr. Beck's company estimated that a system built for this application could not do better than 90% removal of MTBE. That removal efficiency is far too low for most groundwater problems involving MTBE. Because its concentration in gasoline is often as high as 15% and it readily partitions from gasoline into water (a low value of K_{ow} implies that a compound will have a high water concentration in the presence of an organic phase; see Table 1), MTBE is often found in groundwater at concentrations of 1 mg/L and higher. Since clean-up goals for this compound are as low as 0.005 mg/L, a removal of >99.5% is commonly needed, and it can be as high as >99.99%.

It is thus an object of the present invention to provide an improved method for removal of MTBE from water. This and further objects will be more readily apparent when considering the following disclosure and appended claims.

### SUMMARY OF THE INVENTION

The present invention is directed to a method of removing MTBE from an aqueous solution comprising providing a counter-current air stripper in the form of a substantially cylindrical column, said substantially cylindrical column having a top and a bottom, a substantially circular cross section, a longitudinal axis, inlet for the aqueous solution proximate the top of said column and an inlet for air proximate the bottom of said column. The aqueous solution is caused to gravitationally fall within the column while the air is caused to vertically rise within it such that the aqueous solution containing MTBE and the air travel counter-current to one another. The column is at least partially packed with open spherical balls having internal ribs.

### BRIEF DESCRIPTION OF THE FIGURES

The sole FIGURE is a schematic view of a typical column useful in practicing the present invention.

### DETAILED DESCRIPTION OF THE INVENTION

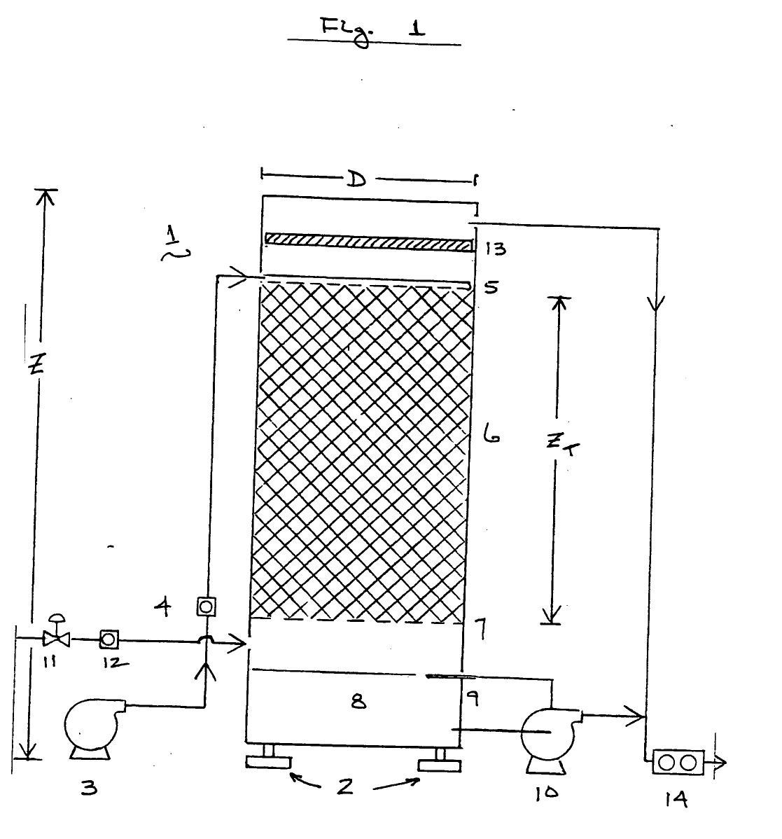

Although there are several ways of carrying out the technology known as air stripping, the packed tower counter-current air stripper requires less air than its alternatives. Since the problem of removing MTBE from water requires the highest efficiency available, the design of FIG. 1 will be employed as the basis for the present invention. The packed tower is a cylindrical column containing a section filled with an inert, engineered material designed to promote maximum interfacial contact between the water phase and the air phase without imposing a high pressure drop on their passage through the tower. The packing can be a monolithic structure manufactured for a specific tower, but it is much more frequently manufactured as discreet pieces from less than 1 inch to about 3 inches in size. The size of the packing is selected depending on the diameter of the tower. The amount needed to fill a section to the desired depth is dumped into the column to create the packed tower. Since water is fed to the top of the packed section and allowed to flow downward over the packing while air is caused to flow upward past the falling water, it is called counter-current.

The selection of the packing is critical to the performance of an air stripper. The selection includes decisions on the type of packing (manufacturer and specific design), the material of construction and the nominal size. A good packing promotes a high interfacial area between the water and the air as the water follows a tortuous path downward through the packed section of the tower. It is important that the individual pieces not become entangled with each other (bridge) because that can lead to a high pressure drop and/or preferential pathways for the water to follow rather than breaking up the flow and creating newly exposed surface area for mass transfer. An inferior packing can also have a limited range of operation. Any packed tower is limited by a phenomenon known as flooding. If too much water is run down the tower, it will not be possible to force sufficient air upwards against the flow to accomplish the required mass transfer. A poorly designed packing will experience flooding at a relatively low flow rate.

Early packing designs were often called “rings.” Pall rings and Raschig rings were very simple shapes, partly because the materials of construction available at the time (ceramics and metal) did not allow for intricate shapes at a reasonable cost. The next generation of packing was at least partly made possible by the use of new materials such as plastics. They were often called “saddles.” Berl saddles, Flexisaddles and others were some improvement over rings, but they tended to bridge and cause relatively high pressure drops. A major breakthrough in packing design came when Jaeger Tri-Packs, Inc. introduced an open spherical packing with internal ribs made out of polypropylene. The spherical shape made bridging impossible, while the open design kept pressure drops very low and the internal ribs forced the water to expose fresh surface areas continuously as it ran down over the packed section. In the 1980's this packing essentially became the standard in the U.S. environmental field where very high removal efficiencies were often necessary to meet stringent permit requirements.

This invention takes the concept of operating a packed tower counter-current air stripper under a total pressure of 100 to 200 millibars and adds the stipulation that the packing selected for MTBE removal be Jaeger Tri-Packs. Polypropylene is the preferred material of construction while the size of the Tri-Packs selected depends on the diameter of the tower being used as follows: No. ½ (nominal 1 inch diameter) for columns 12 inches to 24 inches in diameter, No. 1 (2 inch) for 24 inch to 36 inch columns, and No. 2 (3½ inch) for columns 36 inches in diameter and larger. The diameter of the tower is selected from readily available sizes so that the superficial velocities of the water and the air in the tower yields a point safely below the flooding curve for the selected size of packing.

### REFERENCE TO FIG. 1

A cylindrical tower (1) of suitable materials of construction, such as Schedule 80 PVC pipe, is chosen with an internal diameter D and an overall height Z. The tower (1) is supplied with leveling legs (2) in order to adjust its vertical orientation to within 5% of true vertical. The tower (1) is equipped with appropriate internals, as described below. A pump (3) feeds water containing MTBE through a flow meter (4) and into a distributor (5) oriented horizontally in the tower (1). The distributor releases the water evenly across the entire cross-section of the tower (1) where it flows by gravity over the packed section (6). This section, of height Z_{T}, is filled with Jaeger Tri-Packs sitting on a support plate (7). The packing is made of polypropylene and is selected to have the appropriate nominal size. The water proceeds to fall into the bottom of the tower (1) where it accumulates in a section known as the wet-well (8). The amount of water allowed to accumulate in this lower section is controlled by a level controller (9) which operates an effluent pump (10). Simultaneously to this flow of water downward through the tower (1), clean ambient air enters the system through an air-pressure regulator (11) and an air flow meter (12). The air enters the tower (1) in the section above the wet-well (8) and below the packing support plate (7). The air proceeds to flow upwards through the packed section (6) and then through a demister (13) before exiting the tower (1). A vacuum pump (14) is the motive force that causes the air to flow upwards counter to the flow of water in the tower (1). The air-pressure regulator (11) maintains the total pressure in the tower (1) at its design value, which will typically be 100 to 200 millibars. The demister (13) removes any entrained water from the air stream in order to protect the vacuum pump (14). The flow rates of water and air, as measured by flow meter (4) and flow meter (12), will be adjusted in order to cause the transfer of MTBE from the water stream to the air stream without exceeding the flooding properties of the packing. Therefore, the water leaving the wet-well (8) section of the tower (1) by means of the effluent pump (10) will contain MTBE at or below the design criteria for the system.

### EXAMPLES

A counter-current packed-tower air stripper, as shown in FIG. 1, was constructed out of Schedule 80 PVC. The tower was 12 inches in diameter and included a 7.5 foot packed section filled with 1-inch Jaeger Tri-Packs. A liquid-ring vacuum pump was attached to the tower as shown in FIG. 1. Clean tap water was mixed with MTBE to create the feed water for experimental runs. Tables 2 and 3 present the results of runs performed at a total pressure in the tower of 150 mm Hg and 75 mm Hg, respectively.

TABLE 2
Pilot-Plant Results at Pₛ = 150 mm Hg

| Water Flow | Air Flow Rate, | Feed Water | Effluent Water |
|---|---|---|---|
| Rate, gpm | cgm @ STP | Conc'n, ppb | Conc'n, ppb |
| 5 | 37.8 | 3,100 | 210 |
| 10 | 37.8 | 1,900 | 180 |
| 17 | 37.8 | 825 | 130 |

TABLE 3
Pilot-Plant Results at Pₛ = 75 mm Hg

| Water Flow | Air Flow Rate, | Feed Water | Effluent Water |
|---|---|---|---|
| Rate, gpm | cfm @ STP | Conc'n, ppb | Conc'n, ppb |
| 5 | 18.9 | 1,500 | 99 |
| 10 | 18.9 | 940 | 125 |

These results show a removal of MTBE of 84.2% to 83.4%. The agreement between the calculated percent removal and the observed percent removal varies from 90.1% to 95.5%.

1. A method of removing MTBE from an aqueous solution comprising providing a counter-current air stripper in the form of a substantially cylindrical column, said substantially cylindrical column having a top and a bottom, a substantially circular cross section, longitudinal axis, inlet for said aqueous solution proximate said top and inlet for air proximate said bottom such that said aqueous solution is caused to gravitationally fall within said column and said air is caused to rise within said column counter-current thereto, said column being at least partially packed with open spherical balls having internal ribs.

2. The method of claim 1 wherein said open spherical balls are comprised of polypropylene.

3. The method of claim 1 wherein said substantially cylindrical column is operated at approximately 100-200 millibars of pressure.

4. The method of claim 1 wherein said substantially cylindrical column is characterized as having a diameter between approximately 12 to 24 inches and said open spherical balls are characterized as being approximately 1 inch in diameter.

5. The method of claim 1 wherein said substantially cylindrical column is characterized as having a diameter between approximately 24 to 36 inches and said open spherical balls are characterized as being approximately 2 inches in diameter.

6. The method of claim 1 wherein said substantially cylindrical column is characterized as having a diameter of at least approximately 36 inches and said open spherical balls are characterized as being approximately 3½ inches in diameter.
